(19) United States
(12) Patent Application Publication
(10) Pub. No.: US 2007/0002484 A1
(43) Pub. Date: Jan. 4, 2007

(54) Digital data storage system, recording devices therefor, and digital data storage method

(76) Inventor: Chikashi Okamoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/391,350

(22) Filed: Mar. 29, 2006

(30) Foreign Application Priority Data
Jul. 4, 2005 (JP) 2005-194492

(51) Int. Cl. G11B 19/02

(52) U.S. Cl. 360/69

(57) ABSTRACT

An object of the present invention is to provide a digital data storage technique that allows copyrighted content to be copied from one device to another device without encrypting it in a manner conforming to copyright laws and various specifications. The secondary recording device associates each primary recording device with a different partition and accepts a hard disk processing request for a partition only from the primary recording device associated with it. The secondary recording device deletes a backup copy of copying-inhibited data after restoring it on the primary recording device. The primary recording device prohibits copying-inhibited data from being restored after moving it to a DVD. The primary recording device and the secondary recording device exchange program components to work with each other.

### CLAIM OF PRIORITY

The present application claims priority from Japanese patent application No. JP P2005-194492 filed on Jul. 4, 2005, the content of which is hereby incorporated by reference into this application.

### BACKGROUND OF THE INVENTION

The present invention relates to a digital data storage technique that allows copyrighted content to be copied from one device to another device without encrypting it in a manner conforming to copyright laws and various specifications.

Digital content broadcasting has been spreading due to the terrestrial digital broadcasting service launched on Dec. 1, 2003, etc. However., there is a need for a new technique to prevent unauthorized copying of digital content, since perfect copies of digital content can be effortlessly made, as compared to analog content whose quality degrades when it is copied a number of times, which has discouraged people from illegally copying the analog data.

One conventional method for solving the above problem is CPRM (Content Protection for Recordable Media), a copyright protection technique adopted as a DVD (Digital Versatile Disk) standard. With this technique, the number of copies of each piece of content can be limited to one (see, e.g., page 1 end FIG. 17 of Japanese Patent Laid-open No. 2002-84271).

### SUMMARY OF THE INVENTION

In the case of HDD/DVD recorders, which have been rapidly growing in popularity in recent years, when they have received CPRM-protected content and stored it in their HD (Hard Disk), the content is regarded as having been copied (a first copy). Therefore, these recorders are not allowed to make any more copies of the content if CPRM permits only one copy to be made. In order to further copy the first copy of the content (in a “copying-inhibited” state) to another medium, it is necessary to move it to the medium, instead of simply copying it and hence leaving the first copy as it is. That is, the fist copy must be deleted after it is copied. Further, when CPRM-protected data has been moved to a DVD and therefore it is in a “copying-inhibited” state, the data is not permitted to be re-moved to a HDD (Hard Disk Drive) for copy protection since it can be read by other devices such as a PC (personal computer) even if it is encrypted.

This means that one cannot save content data from a HD to a DVD when the HD is near capacity and then return it to the HD after organizing the data on the HD.

On the other hand, it is possible to temporarily move content data from the HD of a HDD/DVD recorder to an external general-purpose HD when the internal HD is near capacity and later return the content data to it. In this case, however, the content data must be encrypted for copy protection so that there is no meaning in copying it from the external HD to other devices.

Further, if the specification currently used by the system is found to have security vulnerability, the system must switch to a modified or different specification.

The present invention has been devised in view of the above problems. It is, therefore, an object of the present invention to provide a digital data storage technique that allows copyrighted content to be copied from one device to another device without encrypting it in a manner conforming to copyright laws and various specifications.

To solve the above problems, the present invention provides a digital data storage system comprising a first recording device and a second recording device, wherein the first recording device includes: a first hard disk recording unit for storing digital data; and a first cooperation unit for working with the second recording device; and wherein the second recording device includes: a second hard disk recording unit for storing data stored on the first hard disk recording unit; and a second cooperation unit for working with the first recording device.

According to another aspect of the present invention, the second hard disk recording unit accepts a hard disk processing request only from the first recording device.

According to still another aspect of the present invention, when data stored on the second hard disk recording unit is a backup copy of copying-inhibited data stored on the first hard disk recording unit, the second hard disk recording unit deletes the backup copy of the copying-inhibited data after restoring the copying-inhibited data on the first hard disk recording unit from the backup copy.

According to yet another aspect of the present invention, the digital data storage system is further configured such that: the first recording device includes a DVD drive; and when the first recording device has moved the copying-inhibited data stored on the first hard disk recording unit to the DVD drive, the first recording device does not permit the copying-inhibited data to be restored on the first hard disk recording unit from the backup copy of the copying-inhibited data stored on the second hard disk recording unit.

According to yet another aspect of the present invention, the digital data storage system comprises a plurality of the first recording devices, wherein the second hard disk recording unit is divided into a plurality of storage areas, and wherein the second hard disk recording unit associates one of the plurality of storage areas with one of the plurality of first recording devices, stores data received from the one of the plurality of first recording devices onto the one of the plurality of storage areas, and accepts a hard disk processing request only from the one of the plurality of first recording devices if the hard disk processing request is for the one of the plurality of storage areas.

According to yet another aspect of the present invention, the digital data storage system is further configured such that: the first recording device includes a program component that allows the second recording device to work with the first recording device, and the first recording device sends it to the second recording device; and when the second recording device has received the program component sent by the first recording device, the second recording device uses the program component as a control program of the second recording device to work with the first recording device.

According to yet another aspect of the present invention, the digital data storage system is further configured such that: the second recording device includes a program component that allows the first recording device to control the second recording device, and the second recording device sends it to the first recording device; and when the first recording device has received the program component sent by the second recording device, the first recording device uses the program component to control the second recording device.

According to the present invention, the external HDD does not accept content playback, copy, and move requests while it is operating under the control of the HDD/DVD recorder except when the content data is returned to the HDD/DVD recorder. This eliminates the need to encrypt the content data when it is temporarily saved, backed up, etc., resulting in high speed processing.

Further according to the present invention, each HD in the external HDD is partitioned into a plurality of partitions. With this arrangement, the external HDD manages these partitions such that each HDD/DVD recorder can only access its own data. Thus, a plurality of HDD/DVD recorders can be associated with the same external HDD without any problem.

Further according to the present invention, the controller of the HDD/DVD recorder determines whether to store a backup copy on the external HDD. When CPRM-protected content data (in a “copying-inhibited” state) has been moved from the HDD/DVD recorder to a DVD after it has been backed up on the external HDD, the CPRM-protected content data is not permitted to be restored on the HDD/DVD recorder from the backup copy stored on the external HDD. Thus, the HDD/DVD recorder and the external HDD satisfy the CPRM specification.

Further according to the present invention, the HDD/DVD recorder sends a program component to the external HDD to cause the external HDD to operate as an HDCP receiver. Thus, the external HDD can meet the HDCP specification.

Further according to the present invention, the HDD/DVD recorder loads and uses a control client component and an authentication component that match the external HDD used. Therefore, to change the manner in which to control the external HDD, it is only necessary to change or update the control program on the HDD/DVD recorder, allowing the system to accommodate various new specifications.

As described above, the present invention provides a digital data storage technique that allows copyrighted content to be copied from one device to another device without encrypting it in a manner conforming to copyright laws and various specifications.

### BRIEF DESCRIPTION OF THE DRAWINGS

FIG. 1 is a diagram schematically showing the configuration of a HDD/DVD recorder 1 according to the present invention.

FIG. 2 is a diagram schematically showing the configuration of an external HDD 2 according to the present invention.

FIG. 3 is a flowchart showing the operations of a HDD/DVD recorder 1 and an external HDD 2 according to a first embodiment of the present invention.

FIG. 4 is a flowchart showing the operations of a HDD/DVD recorder 1 and an external HDD 2 according to a second embodiment of the present invention.

FIG. 5 is a flowchart showing the operations of first and second HDD/DVD recorders 1 and an external HDD 2 according to a third embodiment of the present invention.

FIG. 6 is a diagram showing an exemplary partition database 224 according to the third embodiment of the present invention.

FIG. 7 is a flowchart showing the operations of a HDD/DVD recorder 1 and an external HDD 2 according to a fourth embodiment of the present invention.

FIG. 8 is a flowchart showing the operations of a HDD/DVD recorder 1 and an external HDD 2 according to a fifth embodiment of the present invention.

FIG. 9 is a diagram showing an exemplary authentication database 225 according to the fifth embodiment of the present invention.

### DESCRIPTION OF THE PREFERRED EMBODIMENTS

Preferred embodiments of the present invention will now be described with reference to systems in which a HDD/DVD recorder and an external general-purpose HDD are used as first and second recording devices, respectively. The HDD/DVD recorder and the external HDD may be hereinafter referred to as the “primary recording device” and the “secondary recording device”, taking their functions into account.

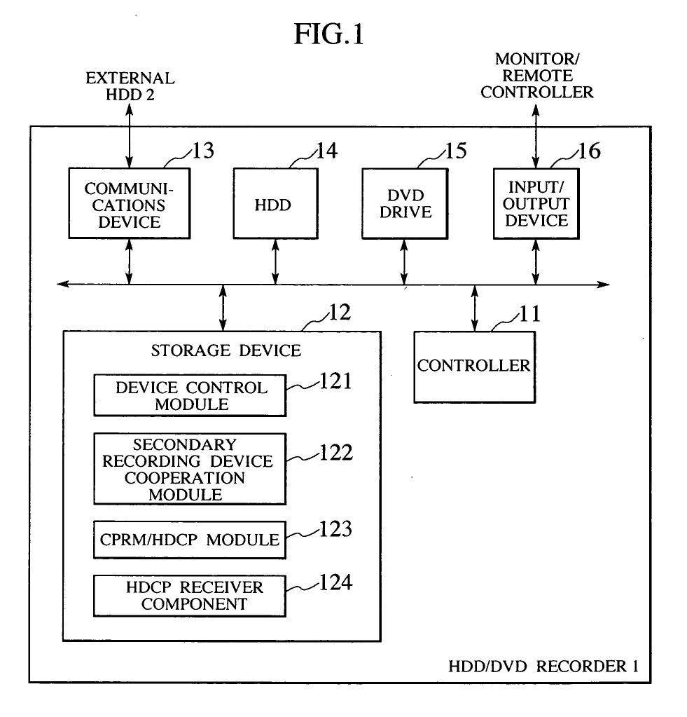

The overall configuration of a HDD/DVD recorder 1 of the present invention will now be described with reference to FIG. 1.

The HDD/DVD recorder 1 of the present invention shown in FIG. 1 includes a controller 11, a storage device 12, a communications device 13, a HDD 14, a DVD drive 15, and an input/output device 16.

The controller 11 executes the processing programs stored in the storage device 12 and controls the operation of the entire HDD/DVD recorder.

The storage device 12 stores processing programs for controlling the operation of the HDD/DVD recorder 1 and control programs for controlling the external HDD 2. The storage device 12 may be, for example, a disk, tape, or a semiconductor. The processing programs stored in the storage device 12 include a device control module 121, a secondary recording device cooperation module (coordinating module) 122, a CPRM/HDCP module 123, and an HDCP receiver component 124.

The device control module 121 coordinates the operations of the components in the HDD/DVD recorder 1, ensuring that the entire HDD/DVD recorder 1 operates properly. For example, the device control module 121 allows these components to perform a recording function to store a TV broadcast program on a HD or DVD and an image management function to copy, move, and delete image data stored on the HD or DVD. The secondary recording device cooperation module 122 allows the HDD/DVD recorder 1 (the primary recording device) to work with the external HDD 2 (the secondary recording device). This module sends various requests to the secondary recording device, as well as authenticating the secondary recording device. The CPRM/HDCP module 123 performs processing specific to the CPRM and HDCP specifications. Specifically, this module controls copy operation and performs authentication/encryption processing. The HDCP receiver component 124 is a program component used to allow the external HDD 2 to operate as an HDCP receiver.

The communications device 13 communicates with the external HDD 2 (the secondary recording device). The communication method may be, for example, USB, IEEE1394, Ethernet®, or wireless LAN.

The HDD 14 is a drive for writing data to and reading data from a hard disk.

The DVD drive 15, on the other hand, is a drive for writing data to and reading data from a DVD.

The input/output device 16 is an interface device used by the user to operate the HDD/DVD recorder 1 and to obtain information from the HDD/DVD recorder 1. The input/output device 16 may be, for example, a button, a switch, a key, a dial, a stick, a pad, a mouse, a remote controller, a touch panel, a monitor, a lamp, a speaker, or a vibrator.

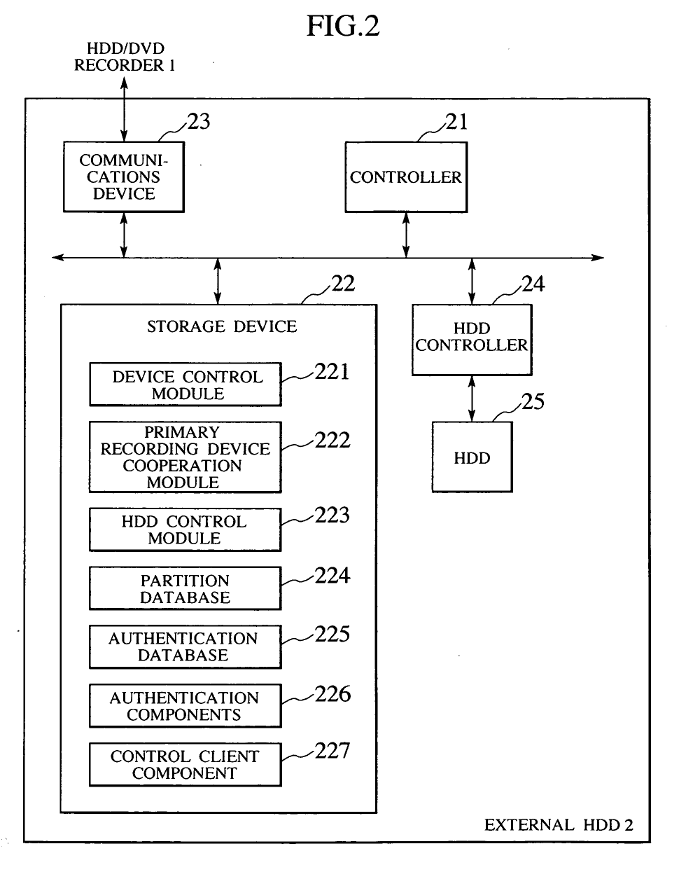

The overall configuration of an external HDD 2 of the present invention will now be described with reference to FIG. 2.

The external HDD 2 of the present invention shown in FIG. 2 includes a controller 21, a storage device 22, a communications device 23, a HDD controller 24, and a HDD 25.

The controller 21 executes the processing programs stored in the storage device 22 and controls the operation of the entire external HDD 2.

The storage device 22 stores processing programs for controlling the operation of the external HDD 2. The storage device 22 may be, for example, a disk, tape, or a semiconductor. The processing programs stored in the storage device 22 include a device control module 221, a primary recording device cooperation module 222, a HDD control module 223, a partition database 224, an authentication database 225, authentication components 226, and a control client component 227.

The device control module 221 coordinates the operations of the components in the external HDD 2, ensuring that the entire external HDD 2 operates properly. For example, the device control module 221 allows these components to perform an image management function to copy, move, and delete image data. The primary recording device cooperation module 222 allows the external HDD 2 (the secondary recording device) to work with the HDD/DVD recorder 1 (the primary recording device). When the external HDD 2 is operating as a secondary recording device for the HDD/DVD recorder 1 (the primary recording device), the primary recording device cooperation module 222 performs processing to prohibit other primary recording devices from accessing the image data copied or moved from the HDD/DVD recorder 1. The HDD control module 223 is a processing program to control the operation of the HDD controller 24. The HDD control module 223 is independent of the device control module 221, which is a processing program for the controller 21 to control the operation of the entire external HDD 2.

The partition data base 224 stores association information between primary recording devices and partitions, indicating which primary recording device is allowed to use which partition. The authentication database 225, on the other hand, stores association information between primary recording devices and authentication key data (or components including the key data), indicating which authentication key data is used for which primary recording device.

The authentication components 226, each including an authentication key, are sent to different primary recording devices to perform authentication processing. The control client component 227 is a program component used by other devices to control the functions of the external HDD 2.

The communications device 23 is used to communicate with the HDD/DVD recorder 1 (the primary recording device). The communication method may be, for example, USB, IEEE1394, Ethernet®, or wireless LAN.

The HDD controller 24 controls the operation of the HDD 25 and is independent of the controller 21, which controls the operation of the entire external HDD 2.

The HDD 25 is a drive for writing data to and reading data from a hard disk.

[First Embodiment]

A first embodiment of the present invention will now be described. According to the first embodiment, in a system in which an external general-purpose HDD 2 (a secondary recording device) is connected to a HDD/DVD recorder 1 (a primary recording device), content data stored on the HDD 14 of the primary recording device is temporarily backed up on the HDD 25 of the secondary recording device and then the content data is restored on the HDD 14 of the primary recording device from the backup copy stored on the HDD 25.

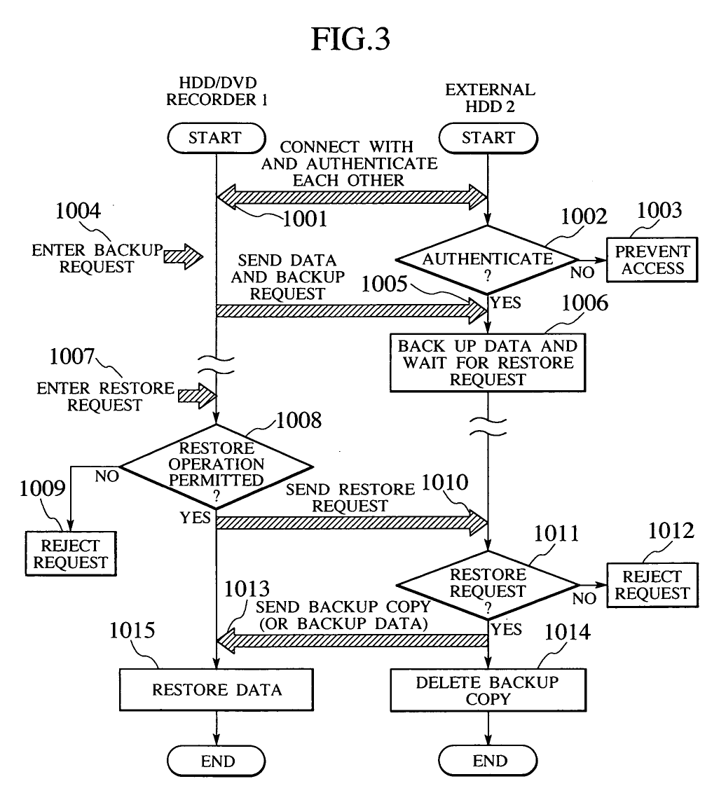

The operations of the HDD/DVD recorder 1 and the HDD 2 according to the present embodiment will be described with reference to FIG. 3.

First, when the secondary recording device has been connected to the primary recording device, the secondary recording device cooperation module 122 running on the controller 11 of the primary recording device and the primary recording device cooperation module 222 running on the controller 21 of the secondary recording device perform processing to authenticate each other at step 1001. If the secondary recording device side has not been able to authenticate the primary recording device side (that is, the decision at step 1002 is no), the HDD control module 223 running on the HDD controller 24 of the secondary recording device prevents access by the primary recording device to the HDD 25 of the secondary recording device at step 1003. If the secondary recording device side has been able to authenticate the primary recording device (that is, the decision at step 1002 is yes), the primary recording device cooperation module 222 running on the controller 21 of the secondary recording device waits for a request from the primary recording device.

Then, when the user has requested the primary recording device to back up data at step 1004, the device control module 121 running on the controller 11 of the primary recording device sends the data stored on the HDD 14 of the primary recording device to the secondary recording device through the communications device 13. In addition, the secondary recording device cooperation module 122 running on the controller 11 of the primary recording device sends a data backup request to the secondary recording device through communications device 13 (step 1005). When the primary recording device cooperation module 222 running on the controller 21 of the secondary recording device has received the backup request from the primary recording device through the communications device 23, the device control module 221 running on the controller 21 of the secondary recording device stores the received data on the HDD 25 of the secondary recording device. In addition, the primary recording device cooperation module 222 running on the controller 21 of the secondary recording device waits for a restore request from the primary recording device (step 1006).

Then, when the user has requested the primary recording device to restore the data at step 1007, the CPRM/HDCP module 123 running on the controller 11 of the primary recording device determines at step 1008 whether the restore operation is permitted. If it is not permitted (that is, the decision at step 1008 is no), the CPRM/HDCP module 123 running on the controller 11 of the primary recording device rejects the restore request at step 1009.

If the restore operation is permitted (that is, the decision at step 1008 is yes), the secondary recording device cooperation module 122 running on the controller 11 of the primary recording device sends a restore request to the secondary recording device through the communications device 13 at step 1010. When the secondary recording device has received a request from the primary recording device through the communications device 23, the primary recording device cooperation module 222 running on the controller 21 of the secondary recording device determines at step 1011 whether the received request is a restore request. If it is not a restore request (that is, the decision at step 1011 is no), the primary recording device cooperation module 222 running on the controller 21 of the secondary recording device rejects the request at step 1012.

If the received request from the primary recording device is a restore request (that is, the decision at step 1011 is yes), then at step 1013, the HDD control module 223 running on the HDD controller 24 of the secondary recording device reads the backup data or backup copy on the HDD 25 of the secondary recording device. In addition, the primary recording device cooperation module 222 running on the controller 21 of the secondary recording device sends the read data to the primary recording device through the communications device 23. After completion of the restore operation, the HDD control module 223 running on the HDD controller 24 of the secondary recording device deletes the backup copy from the HDD 25 of the secondary recording device at step 1014. At step 1015, the device control module 121 running on the controller 11 of the primary recording device stores the backup copy received from the secondary recording device through the communications device 13 onto the HDD 14 of the primary recording device, and the secondary recording device cooperation module 122 running on the controller 11 of the primary recording device completes the restore operation.

This completes the description of the first embodiment of the present invention.

[Second Embodiment]

A second embodiment of the present invention will now be described. The second embodiment is a variation of the first embodiment, wherein: content data stored on the HDD 14 of the primary recording device is CPRM-protected (that is, the content data is in a “copying-inhibited” state); and the data is moved to the DVD drive 15 of the primary recording device after it is backed up on the HDD 25 of the secondary recording device. It should be noted that the following description will be largely directed to functions and operations specific to the second embodiment in order to avoid undue repetition.

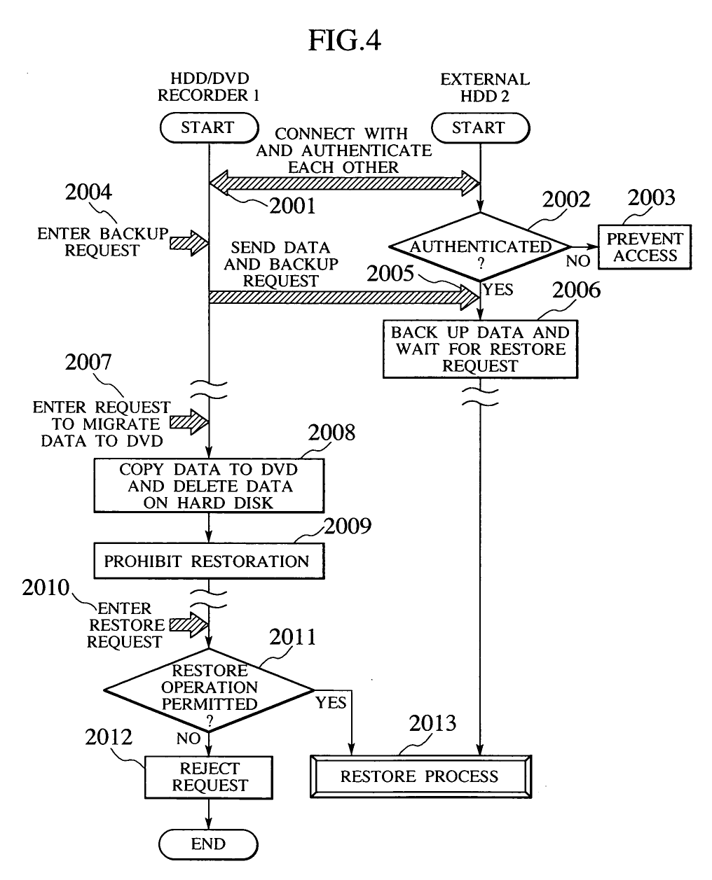

The operations of the HDD/DVD recorder 1 and the external HDD 2 according to the present embodiment will be described with reference to FIG. 4.

First, when the secondary recording device has been connected to the primary recording device, the secondary recording device cooperation module 122 and the primary recording device cooperation module 222 perform processing to authenticate each other at step 2001. If the secondary recording device side has not been able to authenticate the primary recording device side (that is, the decision at step 2002 is no), the HDD control module 223 prevents access by the primary recording device to the HDD 25 at step 2003. If the secondary recording device side has been able to authenticate the primary recording device (that is, the decision at step 2002 is yes), the primary recording device cooperation module 222 waits for a request from the primary recording device.

Then, when the user has requested the primary recording device to back up CPRM-protected content data at step 2004, the device control module 121 sends the data stored on the HDD 14 to the secondary recording device. In addition, the CPRM/HDCP module 123 running on the controller 11 of the primary recording device stores information indicating that the copying-inhibited content data has already been backed up. The secondary recording device cooperation module 122 sends a backup request for the data to the secondary recording device at step 2005. When the primary recording device cooperation module 222 has received the backup request from the primary recording device, the device control module 221 stores the received (content) data on the HDD 25, and the primary recording device cooperation module 222 waits for a restore request (step 2006).

Then, when, at step 2007, the user has requested the primary recording device to move the copying-inhibited content data to a DVD (the content data having been backed up on the secondary recording device at steps 2004 to 2006), the device control module 121 copies the content data stored on the HDD 14 to the disk in the DVD drive 15 and then deletes the content data from the HDD 14 at step 2008. Since the copying-inhibited content data has been moved to the DVD, at step 2009 the CPRM/HDCP module 123 prohibits restoration of the content data from the backup copy stored on the secondary recording device.

Then, when the user has requested the primary recording device to restore the content data at step 2010, the CPRM/HDCP module 123 determines at step 2011 whether the restore operation is permitted. If it is not permitted (that is, the decision at step 2011 is no), the CPRM/HDCP module 123 rejects the restore request at step 2012.

If the restore operation is permitted (that is, the decision at step 2011 is yes), at step 2013 the secondary recording device cooperation module 122 sends a restore request to the secondary recording device to perform the restore operation. The restoring steps that follow are similar to steps 1010 to 1015 of the first embodiment.

This completes the description of the second embodiment of the present invention.

[Third Embodiment]

A third embodiment of the present invention will now be described. A system of the third embodiment is configured such that: data sent from a first HDD/DVD recorder 1 (or primary recording device 1) is stored in a first storage area (or partition A) on the HDD 25 of an external HDD 2 (or secondary recording device), and data sent from a second HDD/DVD recorder 1 (or primary recording device 2) is stored in a second storage area (or partition B) on the same HDD 25; and the secondary recording device manages these storage areas such that each primary recording device can only access its own data.

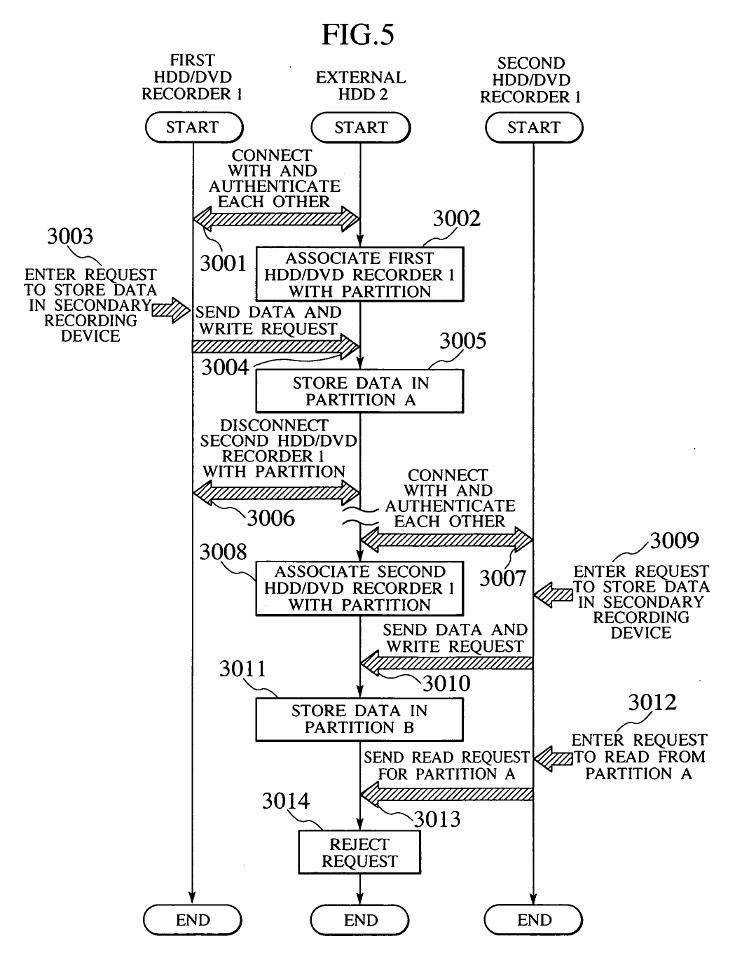

The operations of the first and second HDD/DVD recorders 1 and the external HDD 2 according to the present embodiment will be described with reference to FIG. 5.

First, when the secondary recording device has been connected to the primary recording device 1, the secondary recording device cooperation module 122 of the primary recording device 1 and the primary recording device cooperation module 222 perform processing to authenticate each other at step 3001. The primary recording device cooperation module 222 associates the device ID of the authenticated primary recording device 1 with the partition A (one of the storage areas) on the HDD 25 and stores this association in the partition database 224 at step 3002.

Then, when the user of the primary recording device 1 has requested the primary recording device 1 to store data on the secondary recording device at step 3003, the device control module 121 of the primary recording device 1 sends the data to the secondary recording device. In addition, the secondary recording device cooperation module 122 of the primary recording device 1 sends a write request for the data to the secondary recording device (step 3004). At step 3005, the primary recording device cooperation module 222 searches the partition database 224 for the partition ID associated with the device ID of the connected primary recording device 1 and stores the received data in the partition A associated with the primary recording device 1.

Then, the secondary recording device is disconnected from the primary recording device 1 at step 3006.

Then, when the secondary recording device has been connected to the primary recording device 2, the secondary recording device cooperation module 122 of the primary recording device 2 and the primary recording device cooperation module 222 perform processing to authenticate each other at step 3007. The primary recording device cooperation module 222 associates the device ID of the authenticated primary recording device 2 with the partition B (one of the storage areas) on the HDD 25 and stores this association in the partition database 224 at step 3008. Thus, the primary recording device cooperation module 222 associates the primary recording device 2 with a partition (the partition B) different from the partition A, which is already associated with the primary recording device 1.

Then, when the user of the primary recording device 2 has requested the primary recording device 2 to store data on the secondary recording device at step 3009, the device control module 121 of the primary recording device 2 sends the data to the secondary recording device. In addition, the secondary recording device cooperation module 122 of the primary recording device 2 sends a write request for the data to the secondary recording device (step 3010). At step 3011, the primary recording device cooperation module 222 searches the partition database 224 for the partition ID associated with the device ID of the connected primary recording device 2 and stores the received data in the partition B associated with the primary recording device 2.

Then, when, at step 3012, the user of the primary recording device 2 has requested the primary recording device 2 to read data from the partition A on the secondary recording device, at step 3013 the secondary recording device cooperation module 122 of the primary recording device 2 sends a request to the secondary recording device, requesting that data be read from the partition A. At step 3014, the primary recording device cooperation module 222 searches the partition database 224 for the partition ID associated with the device ID of the connected primary recording device 2, determines that the read request is not for the partition B associated with the primary recording device 2, and hence rejects the read request.

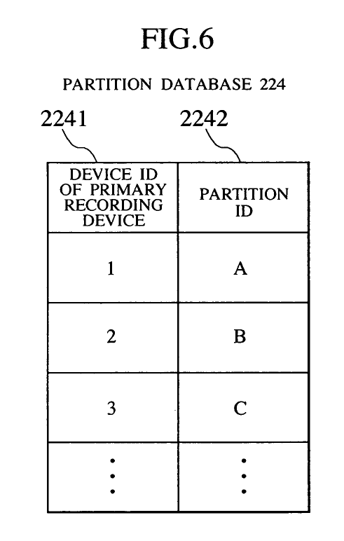

An example of the partition database 224 stored in the storage device 22 according to the present embodiment will now be described with reference to FIG. 6.

As shown in FIG. 6, the partition database 224 stores the device ID 2241 of each primary recording device and the partition ID 2242 of the partition associated with it.

Though not described above, the primary recording device 1 may send a request to the secondary recording device to read from the partition A or the primary recording device 2 may send a request to the secondary recording device to read from the partition B. In either case, the secondary recording device searches the partition database 224 for the partition ID associated with the device ID of the primary recording device, determines that the read request is for the partition associated with the primary recording device, and hence responds to the read request. Further, if the primary recording device 1 has sent a request to the secondary recording device to read from the partition B, the secondary recording device rejects the request since the read request is not for the partition A associated with the primary recording device 1.

Further, although the present embodiment has been described with reference to the case where each primary recording device sends a read request, the present embodiment is not limited to this particular example. The primary recording device may send any access request to the HDD 25 of the secondary recording device (for example, a write request) instead of a read request.

This completes the description of the third embodiment of the present invention.

[Fourth Embodiment]

A fourth embodiment of the present invention will now be described. According to the fourth embodiment, a HDD/DVD recorder 1 (primary recording device) sends a program component to an external HDD 2 (secondary recording device), and upon receiving the program component, the secondary recording device updates its control program with the received program component to work with the primary recording device.

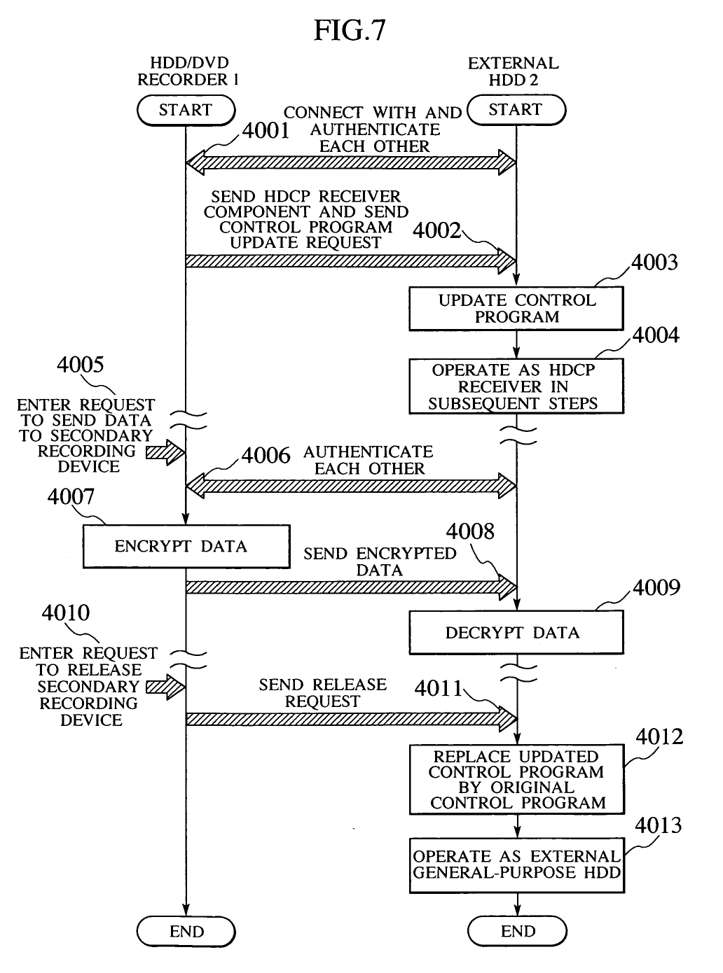

The operations of the HDD/DVD recorder 1 and the external HDD 2 according to the present embodiment will be described with reference to FIG. 7.

First, when the secondary recording device has been connected to the primary recording device, the secondary recording device cooperation module 122 and the primary recording device cooperation module 222 perform processing to authenticate each other at step 4001. At step 4002, the device control module 121 sends an HDCP receiver component 124 to the secondary recording device, and the secondary recording device cooperation module 122 sends a control program update request to the secondary recording device. Upon receiving the control program update request, at step 4003 the primary recording device cooperation module 222 causes the received HDCP receiver component 124 to operate on the controller 21 of the secondary recording device, instead of the device control module 221. As a result, the secondary recording device operates as an HDCP receiver in the subsequent steps (step 4004).

Then, when the user has requested the primary recording device to send data to the secondary recording device at step 4005, the CPRM/HDCP module 123 running on the controller 11 of the primary recording device and the HDCP receiver component 124 running on the controller 21 of the secondary recording device perform processing to authenticate each other through HDCP at step 4006. Then, the CPRM/HDCP module 123 encrypts the data at step 4007, and the device control module 121 sends the encrypted data to the secondary recording device at step 4008. At step 4009, the HDCP receiver component 124 uses the received encrypted data after decrypting it.

Then, when the user has requested the primary recording device to “release” the secondary recording device at step 4010, the device control module 121 sends a release request to the secondary recording device at step 4011. Upon receiving the release request, the primary recording device cooperation module 222 causes the original device control module 221 to operate on the controller 21 of the secondary recording device at step 4012. As a result, the secondary recording device operates as an external general-purpose HDD according to the original device control program (step 4013).

This completes the description of the fourth embodiment of the present invention.

[Fifth Embodiment]

A fifth embodiment of the present invention will now be described. According to the fifth embodiment, an external HDD 2 (secondary recording device) sends an authentication program and a secondary recording device control program to a HDD/DVD recorder 1 (primary recording device), and when the primary recording device has received these programs, the primary recording device uses them to work with the secondary recording device.

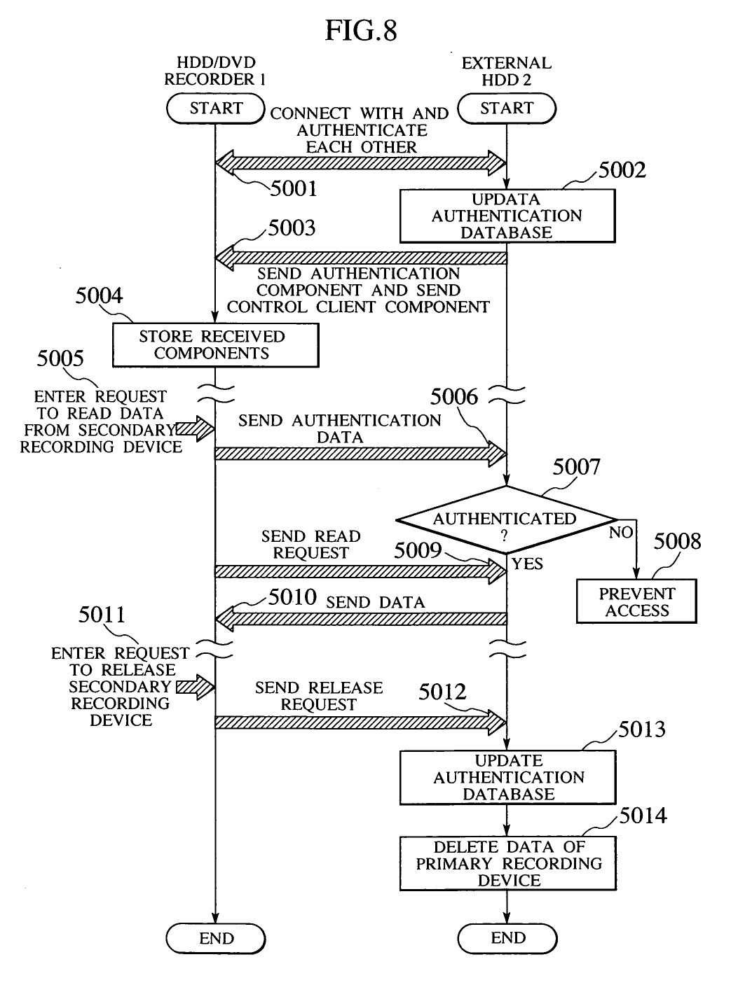

The operations of the HDD/DVD recorder 1 and the external HDD 2 according to the present embodiment will be described with reference to FIG. 8.

First, when the secondary recording device has been connected to the primary recording device, the secondary recording device cooperation module 122 and the primary recording device cooperation module 222 perform processing to authenticate each other at step 5001. At step 5002, from the authentication keys 2251 stored in the authentication database 225, the primary recording device cooperation module 222 selects one that is not associated with the device ID of any primary recording device, associates it with the device ID of the authenticated primary recording device, and stores this association in the authentication database 225.

Then, the device control module 221 sends an authentication component 226 and a control client component 227 to the primary recording device at step 5003. The device control module 121 stores the authentication component 226 and control client component 227 in the storage device 12 at step 5004. It should be noted that the secondary recording device cooperation module 122 uses the authentication component 226 and the control client 227 stored in the storage device 12 when the primary recording device needs to work with the secondary recording device.

In the following example, the primary recording device reads data that has been previously stored on the secondary recording device using steps 3001 to 3005 described in connection with the third embodiment, for example.

First, when the user has requested the primary recording device to read data from the secondary recording device at step 5005, the secondary recording device cooperation module 122 sends authentication data to the secondary recording device using the authentication component 226 at step 5006. The primary recording device cooperation module 222 searches the authentication database 225 for the authentication key associated with the device ID of the connected primary recording device and performs authentication processing on the primary recording device using the found authentication key at step 5007.

If the primary recording device cooperation module 222 has not been able to authenticate the primary recording device side (that is, the decision at step 5007 is no), the HDD control module 223 prevents access by the primary recording device to the HDD 25 at step 5008. If the primary recording device cooperation module 222 has been able to authenticate the primary recording device (that is, the decision at step 5007 is yes), the primary recording device cooperation module 22 waits for a request from the primary recording device.

At step 5009, the secondary recording device cooperation module 122 sends a read request to the secondary recording device using the control client component 227. Then, the primary recording device cooperation module 222 receives the read request and determines that it has been sent using the control client component 227. At step 5010, the HDD control module 223 reads the data from the HDD 25, and the primary recording device cooperation module 222 sends the read data to the primary recording device.

Then, when, at step 5011, the user has requested the primary recording device to “release” the secondary recording device, the secondary recording device cooperation module 122 sends a release request to the secondary recording device using the control client component 227 at step 5012. Upon receiving the release request, at step 5013 the primary recording device cooperation module 222 updates the authentication database 225 so that the association between the device ID of the primary recording device and the authentication key is deleted and hence no primary recording device is associated with the authentication key.

When the secondary recording device has been operating as a dedicated external HDD for the primary recording device, the HDD control module 223 deletes the data of the primary recording device from the HDD 25 at step 5014. As a result, the secondary recording device operates as an external general-purpose HDD.

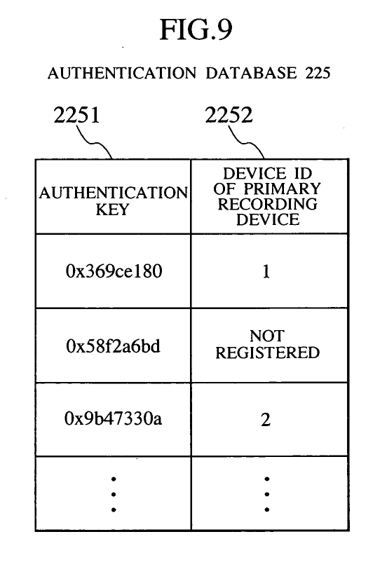

An example of the authentication database 225 stored in the storage device 22 according to the present embodiment will now be described with reference to FIG. 9.

As shown in FIG. 9, the authentication database 225 stores each authentication key 2251 and the device ID 2252 of the primary recording device associated with it.

It should be noted that although the present embodiment has been described with reference to the case where the primary recording device receives the authentication component 226 and the control client component 227 directly from the secondary recording device, the present embodiment is not limited to this particular arrangement. The primary recording device may download them from the website of the manufacturer of the secondary recording device via the Internet, instead of directly receiving them from the secondary recording device.

Further, although in the present embodiment the authentication database 225 stores the authentication keys 2251 in association with the device IDs 2252 of the primary recording devices, any information that allows verification of the authentication data sent from the primary recording devices may be associated with the device IDs of the primary recording devices, instead of the authentication key data. For example, when asymmetric encryption is used, the verification key for the authentication data (the authentication key) may be used. Further, the component ID of the authentication component may be used. This case requires a database for storing associations between component IDs and authentication data.

This completes the description of the fifth embodiment of the present invention.

The first to fifth embodiments of the present invention have been described.

It should be noted that although the above preferred embodiments of the present invention have been described with reference to the case where the controller 21 and the HDD controller 24 of the external HDD 2 are separate controllers, the present invention is not limited to this particular arrangement. The same controller may act as both the controller 21 and the HDD controller 24.

Further, although the above preferred embodiments of the present invention have been described as including the CPRM/HDCP module 123 to accommodate CPRM and HDCP specifications, they may include a module that meets other specifications.

Further, although in the above preferred embodiment of the present invention, after connection of the primary and secondary recording devices, the secondary recording device cooperation module 122 and the primary recording device cooperation module 222 perform authentication processing to authenticate each other, the device control module 121 of the primary recording device and the device control module 221 of the secondary recording device may perform authentication processing, instead.

It should be further noted that although the above preferred embodiments of the present invention have been described with reference to the case where the partition database 224 and the authentication database 225 are separate databases, the present invention is not limited to this particular arrangement. They may be combined into a single database.

According to preferred embodiments of the present invention, the external HDD does not accept content playback, copy, and move requests while it is operating under the control of the HDD/DVD recorder except when the content data is returned to the HDD/DVD recorder. This eliminates the need to encrypt the content data when it is temporarily saved, backed up, etc., resulting in high speed processing.

Further according to preferred embodiments of the present invention, each HD in the external HDD is partitioned into a plurality of partitions. With this arrangement, the external HDD manages these partitions such that each HDD/DVD recorder can only access its own data. Thus, a plurality of HDD/DVD recorders can be associated with the same external HDD without any problem.

Further according to preferred embodiments of the present invention, the controller of the HDD/DVD recorder determines whether to store a backup copy on the external HDD. When CPRM-protected content data (in a “copying-inhibited” state) has been moved from the HDD/DVD recorder to a DVD after it has been backed up on the external HDD, the CPRM-protected content data is not permitted to be restored on the HDD/DVD recorder from the backup copy stored on the external HDD. Thus, the HDD/DVD recorder and the external HDD satisfy the CPRM specification.

Further according to the present invention, the HDD/DVD recorder sends a program component to the external HDD to cause the external HDD to operate as an HDCP receiver. Thus, the external HDD can meet the HDCP specification.

Further according to preferred embodiments of the present invention, the HDD/DVD recorder loads and uses a control client component and an authentication component that match the external HDD used. Therefore, to change the manner in which to control the external HDD, it is only necessary to change or update the control program in the HDD/DVD recorder, allowing the system to accommodate various new specifications.

What is claimed is:

1. A digital data storage system comprising a first recording device and a second recording device,
wherein said first recording device includes:
a first hard disk recording unit for storing digital data; and
a first cooperation unit for working with said second recording device; and
wherein said second recording device includes:
a second hard disk recording unit for storing data stored on said first hard disk recording unit; and
a second cooperation unit for working with said first recording device.

2. The digital data storage system as claimed in claim 1, wherein said second hard disk recording unit accepts a hard disk processing request only from said first recording device.

3. The digital data storage system as claimed in claim 2, comprising a plurality of said first recording devices,
wherein said second hard disk recording unit is divided into a plurality of storage areas, and
wherein said second hard disk recording unit associates one of said plurality of storage areas with one of said plurality of first recording devices, stores data received from said one of said plurality of first recording devices onto said one of said plurality of storage areas, and accepts a hard disk processing request only from said one of said plurality of first recording devices if said hard disk processing request is for said one of said plurality of storage areas.

4. The digital data storage system as claimed in claim 1, wherein when data stored on said second hard disk recording unit is a backup copy of copying-inhibited data stored on said first hard disk recording unit, said second hard disk recording unit deletes said backup copy of said copying-inhibited data after restoring said copying-inhibited data on said first hard disk recording unit from said backup copy.

5. The digital data storage system as claimed in claim 4, wherein:
said first recording device includes a DVD drive; and
when said first recording device has moved said copying-inhibited data stored on said first hard disk recording unit to said DVD drive, said first recording device does not permit said copying-inhibited data to be restored on said first hard disk recording unit from said backup copy of said copying-inhibited data stored on said second hard disk recording unit.

6. The digital data storage system as claimed in claim 1, wherein:
said first recording device includes a program component that allows said second recording device to work with said first recording device, and said first recording device sends said program component to said second recording device; and
when said second recording device has received said program component sent by said first recording device, said second recording device uses said program component as a control program of said second recording device to work with said first recording device.

7. The digital data storage system as claimed in claim 1, wherein:
said second recording device includes a program component that allows said first recording device to control said second recording device, and said second recording device sends said program component to said first recording device; and
when said first recording device has received said program component sent by said second recording device, said first recording device uses said program component to control said second recording device.

8. A first recording device comprising:
a first hard disk recording unit for storing digital data;
a first cooperation unit for working with a second recording device; and
a DVD drive;
wherein when said first recording device has moved copying-inhibited data stored on said first hard disk recording unit to said DVD drive, said first recording device does not permit said copying-inhibited data to be restored on said first hard disk recording unit from a backup copy of said copying-inhibited data stored on said second recording device.

9. The first recording device as claimed in claim 8, further comprising a program component that allows said second recording device to work with said first recording device,
wherein said first recording device sends said program component to said second recording device.

10. The first recording device as claimed in claim 8, wherein: from said second recording device, said first recording device receives a program component that allows said first recording device to control said second recording device; and
said first recording device uses said program component to control said second recording device.

11. The first recording device as claimed in claim 8 is a HDD/DVD recorder.

12. A second recording device comprising:
a second hard disk recording unit for storing data stored on a first recording unit; and
a second cooperation unit for working with said first recording unit;
wherein said second hard disk recording unit accepts a hard disk processing request only from said first recording device.

13. The second recording device as claimed in claim 12, wherein:
said second hard disk recording unit is divided into a plurality of storage areas; and
said second hard disk recording unit associates one of said plurality of storage areas with one of a plurality of said first recording devices, stores data received from said one of said plurality of first recording devices onto said one of said plurality of storage areas, and accepts a hard disk processing request only from said one of said plurality of first recording devices if said hard disk processing request is for said one of said plurality of storage areas.

14. The second recording device as claimed in claim 12, wherein when data stored on said second hard disk recording unit is a backup copy of copying-inhibited data stored on said first recording device, said second hard disk recording unit deletes said backup copy of said copying-inhibited data after restoring said copying-inhibited data on said first recording device from said backup copy.

15. The second recording device as claimed in claim 12, wherein:
from said first recording device, said second recording device receives a program component that allows said second recording device to work with said first recording device; and
said second recording device uses said program component as a control program of said second recording device to work with said first recording device.

16. The second recording device as claimed in claim 12, further comprising a program component that allows said first recording device to control said second recording device,
wherein said second recording device sends said program component to said first recording device, and
wherein said second recording device operates according to a control operation that said first recording device performs by use of said program component.

17. The second recording device as claimed in claim 12 is an external HDD.

18. A method for storing digital data, performed by a first recording device and a second recording device in cooperation, said method comprising the steps, performed by said second recording device, of:
storing a device ID of said first recording device and information indicating a storage area of said second recording device in association with each other;
upon receiving a processing request from said first recording device, determining whether said processing request is for said storage area associated with said device ID of said first recording device; and
if said processing request is not for said storage area associated with said device ID of said first recording device, rejecting said processing request.

19. A method for storing digital data, performed by a first recording device and a second recording device in cooperation, said method comprising the steps of:
storing a backup copy of digital data stored on said first recording device onto said second recording device;
allowing said second recording device to reject any request other than that received from said first recording device;
allowing said second recording device to reject any request other than a restore request received from said first recording device;
in response to said restore request from said first recording device, allowing said second recording device to restore said digital data on said first recording device from said backup copy; and
allowing said second recording device to delete said backup copy.

20. The method as claimed in claim 19, further comprising the step of:
upon moving copying-inhibited data to a DVD drive, allowing said first recording device to reject a restore request to restore said copying-inhibited data on said first hard disk recording unit from said backup copy of said copying-inhibited data stored on said second recording device.
